(19) United States
(12) Patent Application Publication
(10) Pub. No.: US 2012/0275632 A1
(43) Pub. Date: Nov. 1, 2012

(54) EARPHONE

(75) Inventor: CHENG-HOUNG HUANG, Kowloon (HK)

(73) Assignee: Comaxtech International Limited, Kowloon (HK)

(21) Appl. No.: 13/151,565

(22) Filed: Jun. 2, 2011

(30) Foreign Application Priority Data
Apr. 26, 2011 (TW) 100207371

(51) Int. Cl. H04R 1/02

(52) U.S. Cl. 381/345

(57) ABSTRACT

An improved earphone comprises a shield member consisting of a front shield part and a rear shield part, and a speaker unit. The front shield part is provided with a cover section with an egg-shaped profile, and has a front side which has a little concave outward shape. The rear shield part extends and converges from the front shield part gradually to form a circular cone section, and further extends to form a connecting tube section. The speaker unit is disposed in the receiving room of the front shield part, and has a center deviates from the center of the front shield. In this way, the earphone can be plugged to the ear tightly, and the speaker unit is capable of aligning with the external auditory canal precisely to concentrate the sound and lessen volume and base of the sound being lost for enhancing the sound quality.

### BACKGROUND OF THE INVENTION

1. Field of the Invention

The present invention relates to an earphone, and, more particularly, to an improved earphone which is capable of enhancing the tone quality and lessening volume and bass being lost.

2. Description of Related Art

The earphone was developed for the user to enjoy sound from the electronic sound effect device personally without bothering others. The conventional earphone usually is open type to be plugged to the ear as shown in FIGS. 6 and 7; a raw speaker in the earphone emits the sound which enters the external auditory canal of the ear and then reaches the ear drum such that the user can feel the sound. But, the currently used open type earphone is limited with the design of circular ear cap as shown in FIG. 6, and it dose not coincide with the ear hole such that it is incapable of closing the external auditory canal tightly, and, under the circumferences, the sound emitted via the speaker is short of the bass seriously. In addition, the external auditory canal being incapable of being blocked completed with the ear cap results in the sound emitted from the raw speaker is not possible to enter the external auditory canal completely.

In order to enhance a feeling of wearing and increasing the tightness of the external auditory canal, some of the open type earphones are provided with an oval-shaped ear cap as shown in FIG. 7. In this way, although it is much better for coinciding with the ear hole, the raw speaker in the oval-shaped ear cap is disposed to align with the center of the ear cap as the circular-shaped earphone does such that the sound emitted from the raw speaker is not possible to enter the external auditory canal completely as well; especially, the problem concerning shortage of the bass is the major deficiency thereof.

### SUMMARY OF THE INVENTION

The main objective of the present invention is to provide an improved earphone to overcome the preceding deficiency of the conventional earphone.

To achieve the objective, the improved earphone according the present invention comprises:
a shield member consisting of a front shield part and a rear shield part, wherein the front shield part is provided with a cover section with an egg-shaped profile, and has a front side which has a little concave outward shape; the rear shield part extends and converges from the front shield part gradually to form a circular cone section, and further extends to form a connecting tube section;
a speaker unit disposed in the receiving room of the front shield part, and has a center deviates from the center of the front shield.
Thus, the earphone can be plugged to the ear tightly, and the speaker unit is capable of aligning with the external auditory canal precisely to concentrate the sound and lessen volume and base of the sound being lost for enhancing the sound quality.

### BRIEF DESCRIPTION OF THE DRAWINGS

Further benefits and advantages of the present invention will become apparent after a careful reading of the detailed description with appropriate reference to the accompanying drawings.

FIG. 1 is a front view of an improved earphone according to the present invention;

FIG. 2 is a side view of an improved earphone according to the present invention;

FIG. 3 is a sectional view along line A-A shown in FIG. 1;

FIG. 4 is a plan view illustrating the earphone of the invention being plugged to an ear;

FIG. 5 is a graph showing frequency response curves with respect to the earphone of the invention and the conventional earphone;

FIG. 6 is a plan view illustrating the conventional circular earphone being plugged to the ear;

FIG. 7 is a plan view illustrating the conventional oval earphone being plugged to the ear.

### DETAILED DESCRIPTION OF THE INVENTION

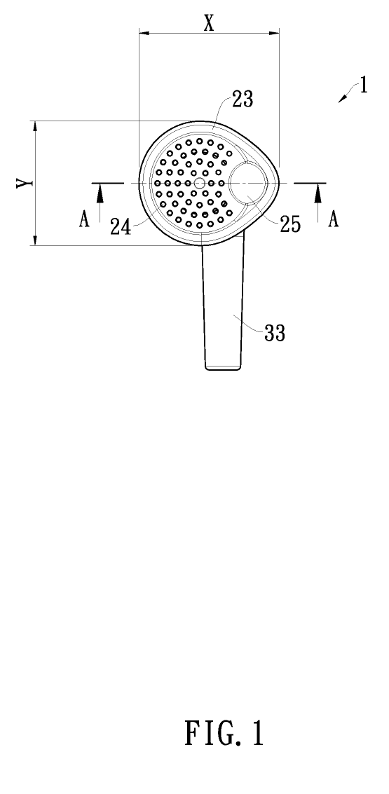

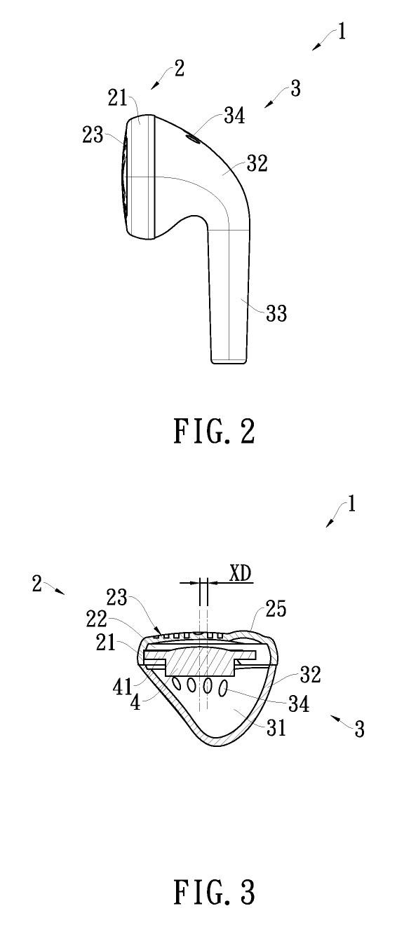

Referring to FIGS. 1-3, a preferred embodiment of an improved earphone in accordance with the present invention comprises a shield member 1 composed of a front shield part 2 and a rear shield part 3; the front shield part 2 is provided with a cover section 21 which has an egg-shaped profile with a large circular lateral side and a small circular lateral side thereof opposite to each other; the front shield part 2 has an inner receiving room 22 next to the front side 23 of the cover section 21 as shown in FIG. 1, and the front side 23 is a little concave outward shape with a plurality of guiding sound apertures 2, and further has a projection area 25 disposed next to the guiding sound apertures 2 for being marked such as a letter “R” (abbreviation of right side) thereon. In practice, the front shield part 2 has a horizontal distance X between the large circular lateral side and the small circular lateral side and a vertical distance Y between the top and the bottom thereof as shown in FIG. 1, and it is preferably that the horizontal distance X is 18 mm±1 mm and the vertical distance Y is 16 mm±1 mm. The rear shield part 3 extends and converges from the front shield part 2 gradually to form a circular cone section 32, and further extends and converges to form a connecting tube section 33; the rear shield part 3 has a sound chamber 31 and a through hole 34. The earphone of the present invention further comprises a speaker unit 4 which has a projecting outward ring section 41 disposed in the receiving room 22 of the front shield part 2. The center of the front shield part 2 deviates a clearance from the center of the speaker unit 4, and the clearance is 1 mm±0.2 mm.

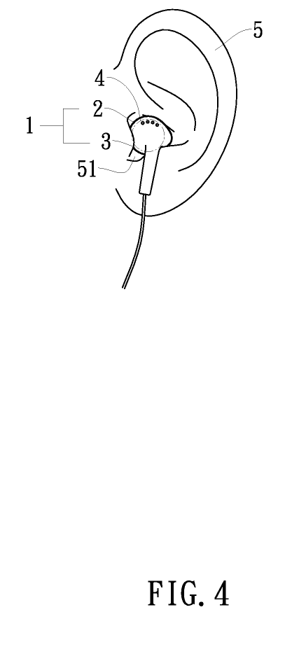

Referring to FIG. 4 in company with FIGS. 1-3, the shield member 1 is egg-shaped to converge gradually such that it matches the shape of the ear 5 in a way of the front shield part 2 closely contacting the outer side 51 of the external auditory canal for enhancing tightness; Further, the speaker unit 4 is disposed at the front side and deviates from the front shield part 2 a clearance such that the speaker unit 4 is capable of aligning with the external auditory canal to concentrate the sound and lessen volume and bass of the sound being lost for improving tone quality greatly.

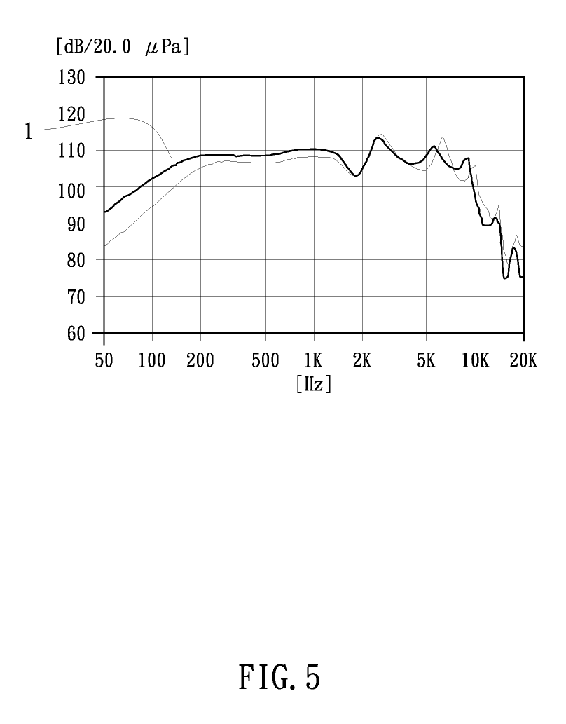

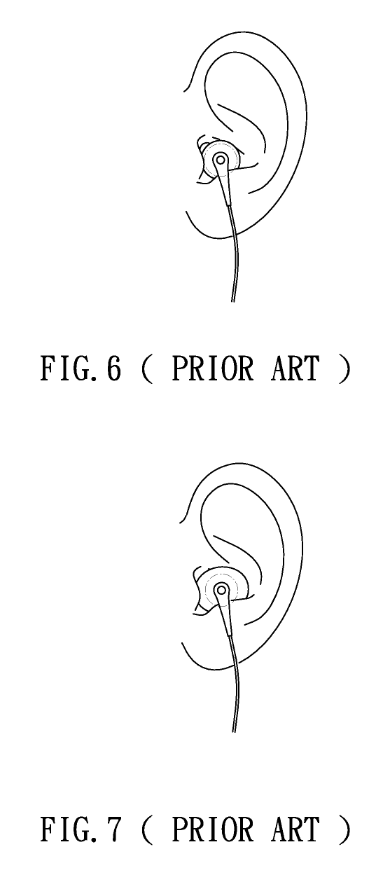

Referring to FIG. 5, it can be seen that comparison of the frequency response of the ear according to the present invention with that of the conventional earphone. The shield member 1 is egg-shaped to converge gradually to match the shape of the ear 5, and the trumpet unit 4 is disposed to deviate from the front shield 2 such that the earphone can be plugged to the ear tightly, and the speaker unit 4 is capable of aligning with the external auditory canal to concentrate the sound and lessen volume and base of the sound being lost. Therefore, the frequency response of the earphone of the invention represented with the upper curve shown in FIG. 5 is more effective than the frequency response of the conventional earphone represented with the lower curve. This is why the tone quality of the earphone of the present invention is much better than that of the conventional earphone.

Although the invention has been explained in relation to its preferred embodiment, it is to be understood that many other possible modifications and variations can be made without departing from the spirit and scope of the invention as hereinafter claimed.

What is claimed is:

1. An improved earphone comprising:
a shield member consisting of a front shield part and a rear shield part, wherein the front shield part has a center, is provided with a cover section with an egg-shaped profile, and a receiving room therein next to the cover section;
a speaker unit being disposed in the receiving room, and has a center deviates from the center of the front shield.

2. The improved earphone as defined in claim 1, wherein said front shield part has a front side which has a little concave outward shape and a plurality of guiding sound apertures.

3. The improved earphone as defined in claim 2, wherein said front shield part has a projection area next the guiding sound apertures.

4. The improved earphone as defined in claim 3, wherein the egg-shaped cover section has a horizontal distance 18 mm±1 mm between two lateral sides thereof and a vertical distance 16 mm±1 mm between the top and the bottom thereof.

5. The improved earphone as defined in claim 4, wherein rear shield part extends and converges from the front shield part gradually to form a circular cone section to provide a sound chamber.

6. The improved earphone as defined in claim 1, wherein a clearance is between the center of the speaker unit and the center of the front shield part.

7. The improved earphone as defined in claim 6, wherein the clearance is 1 mm±0.2 mm.

8. The improved earphone as defined in claim 5, wherein the rear shield part further extends and converges to form a connecting tube section.

9. The improved earphone as defined in claim 8, wherein the rear shield part further has a through hole.

10. The improved earphone as defined in claim 6, wherein the rear shield part further extends and converges to form a connecting tube section.

11. The improved earphone as defined in claim 10, wherein the rear shield part further has a through hole.

12. The improved earphone as defined in claim 7, wherein the rear shield part further extends and converges to form a connecting tube section.

13. The improved earphone as defined in claim 12, wherein the rear shield part further has a through hole.
